(19) United States
(12) Patent Application Publication
(10) Pub. No.: US 2005/0105508 A1
(43) Pub. Date: May 19, 2005

(54) System for management of Internet telephony equipment deployed behind firewalls

(75) Inventor: Partha Saha, Oakland, CA (US)

Correspondence Address: TIMOTHY P. O'HAGAN, 8710 KILKENNY CT, FORT MYERS, FL, 33912, US

(73) Assignee: Innomedia Pte Ltd., The Alpha (SG)

(21) Appl. No.: 10/713,481

(22) Filed: Nov. 14, 2003

(51) Int. Cl. H04L 12/66

(52) U.S. Cl. 370/352

(57) ABSTRACT

A sub-manager interfaces between a traditional SNMP network management system (NMS) a plurality of clients, each of which may be served by a network address and port translation firewall. The sub-manager operates a master management information base and receives master network management request messages from the network management server. The master network management request message includes at least one master object identifier which comprises a client identifier which identifies a particular one of the clients and a variable portion that identifies a variable value within a client management information base. The sub-manager, in response, generates one or more client network management request messages to identified clients over TCP/IP connections through the firewall. The client network management request message includes a client object identifier that identifies the variable within the client management information base.

### TECHNICAL FIELD

The present invention relates to the management of Internet telephony equipment deployed behind firewalls and more particularly to a system for interfacing between equipment deployed behind a firewall and a simple network management protocol (SNMP) based Network Management System (NMS).

### BACKGROUND OF THE INVENTION

Development of the Internet protocols (IP) has facilitated widespread deployment of IP compliant packet switched networks for transferring of data between devices. Further, the IP addressing scheme enables the interconnecting of these IP compliant networks forming the Internet. When a device is coupled to an IP compliant network it is assigned an IP address. If the IP address is globally unique, any remote device can address IP compliant frames to the device using such globally unique IP address.

Because of the limited number of IP addresses available, certain blocks of IP addresses, referred to as private network addresses, have been set aside for use on private networks. These private network IP addresses are assigned and maintained locally and are therefore routable only on the local area network (LAN) on which the private network IP address is unique. Private network IP addresses are not globally routable on the Internet. A network address translation system (NAT) is used to couple the LAN to the Internet in a manner that enables all of the devices on the LAN to share the globally unique Internet routable IP address(es) assigned to the NAT system.

A NAT system does not allow any global Internet entity to connect to any private LAN entity unless the NAT system is configured with specific connection rules to enable certain LAN entities to operate as servers for clients outside the LAN. As such, a NAT system protects LAN entities from outside intrusion acting, as is known in the networking literature, as a “firewall”.

In a separate but related field of development, the Simple Network Management Protocols (SNMP) has been developed to enable a centrally located network management system (usually referred to an “NMS”) to monitor a large number of client devices (each operating as an SNMP agent) coupled to the network.

Each SNMP compliant agent implements relevant sections of a management information base (MIB) that includes variables required for monitoring, configuring, and controlling the client device. The SNMP protocol specifies a set of messages that may be exchanged between the NMS and each agent for the exchange of values associated with variables defined by the MIB. The SNMP messages are usually exchanged using the connectionless UDP/IP protocol. More specifically, SNMP messages are sent to an agent by addressing the message to the agent using the agent's IP address and UDP port 161. Responses are returned to the NMS by addressing the response to the NMS's IP address and the dynamic port from which the NMS sent the original message to the agent. Asynchronous Traps (unsolicited messages sent by the agent to the NMS) are sent to the NMS's IP address and UDP port 162.

A challenge with use of the SNMP protocols on a private network with private network IP addresses is that the messages may only be sent to an agent if the NMS is on the same LAN such that the agent's private network IP address is routable. An NMS on the global side of a NAT system can-not manage an agent on the private network side of the NAT system utilizing the messaging protocols discussed above because it can-not reach the entities with private network addresses.

To enable SNMP based management of a plurality of devices deployed on different kinds of networks that may not all be reachable by a single NMS, hierarchical distribution systems have been developed. A NMS may manage the plurality of devices through various distribution agents which act as SNMP “proxy” agents for the devices. There exists a distribution agent (with a private network IP address) on each LAN for managing the agents (with private network IP addresses) on that particular LAN. The distribution agent communicates each SNMP message with the NMS using traditional SNMP messaging through a “permanent hole” configured thought the LAN's firewall and communicates each SNMP message with the managed agent using SNMP messaging over the LAN.

A first problem with existing hierarchical solutions is that they require that a distribution agent to be present on each LAN on which a managed agent is located. In the context of managing Internet telephony devices, there may only be a small quantity of managed Internet telephony devices coupled to each LAN—such as one or two. As such, use of an existing hierarchical solution would require a quantity of distribution agents that approaches the number of Internet telephony devices deployed. Deploying such a large number of distribution agents is not practical.

A second problem with existing hierarchical solutions is that the distribution agent is only a distribution agent. The NMS must still individually manage each device. In the context of Internet telephony devices it is contemplated that hundreds of thousands of Internet telephony devices will require management. While the distribution agent can expand the reach of the NMS to a private network, the distribution agent does nothing to expand the total number of devices that the NMS can manage without overwhelming its processing capacity.

A third problem with the existing hierarchical solutions is that the private network on which the distribution agent is located must be manually configured to enable the distribution agent to communicate with the NMS through a firewall hole. In the context of managing Internet telephony devices, the Internet telephony service provider will not have control over each LAN and will not be able to configure the LAN's firewall to permit the traditional UDP/IP communication between the NMS and the distribution agent.

What is needed is a NMS sub-manager system useful for managing a large number of Internet telephony devices. It is desirable that such sub-manager system expand the number of devices that an NMS can manage and expand the reach of the NMS to private networks without requiring placement of a distribution agent on each private network or the reconfiguration of a NAT system.

### SUMMARY OF THE INVENTION

A first aspect of the present invention is to provide a sub-manager for interfacing between a traditional SNMP NMS and a plurality of clients, each of which may be served by a network address and port translation firewall.

The sub-manager comprises: i) a network management agent for exchanging aggregated and non-aggregated request-response messages and asynchronous Trap and Inform messages with the NMS utilizing traditional SNMP over UDP/IP channels; and ii) a connections module and device state machines for opening and maintaining a TCP/IP network connection with each of the plurality of clients, each of which may be on the private side of a NAT firewall. The sub-manager further includes a message handling module and request state machines for interconnecting the network management agent with the connection module and device state machines.

This message handling module, on receiving a message from the NMS, spawns a request state machine. The request state machine may generate at least one corresponding client request message. The client request message is provided to a device state machine which in turn provides the client request message to the client over the TCP/IP connection established with such client.

Messages exchanged between the sub-manager and the NMS are referred to as “master network management” messages while those exchanged between the sub-manager and the clients are referred to as “client network management” messages.

The master network management request message includes a master object identifier which identifies a variable within a master management information base. The master object identifier comprises a client ID portion that identifies a particular client and a portion that identifies the variable within a management information base of the identified client (e.g. a client management information base).

The client network management request message includes a client object identifier that identifies the variable within the client management information base. A client response message may be received from the client over the TCP/IP connection. The client response message includes the client object identifier and a value of the variable associated with the client object identifier. After receiving a client response message, the request state machine may generate or aggregate a master response message to be delivered via SNMP to the NMS. The master response message includes the master object identifier with the value of the variable associated therewith.

Each TCP/IP connection, established with a client through the firewall serving such client, is established in response to receiving a connection request initiated by such client. An identification of each TCP/IP connection is recorded in an open connections table in association with a client identifier which identifies the client that initiated the connection. The client provides the client identifier during the TCP/IP connection creation handshake. In a simple implementation of this connection establishment scheme, one TCP/IP connection is maintained per client—thus an open TCP/IP connection uniquely identifies a client and vice versa.

To verify that the TCP/IP connection is open through the firewall, the sub-manager may periodically exchange a TCP/IP frame with the client over the connection. The sub-manager may determine that an open connection does not exist with the client if either: i) the periodic TCP/IP frame has not been received from the client for a predetermined time out period; or ii) the TCP/IP connection has been terminated. The sub-manager will then wait for the connection to be re-established by the client. In the event that a connection to a client does not exist, the master response message includes an indication that the value is unavailable.

The sub-manager may further receive an asynchronous client Trap or Inform message from a client over the TCP/IP connection established with the client. In response to receiving such a Trap or Inform message, the message handling module will identify the client that initiated the asynchronous client Trap or Inform message and generate or aggregate a corresponding asynchronous master Trap or Inform message that is to be provided to the NMS. The asynchronous client Trap or Inform message will include a variable value and a client object identifier associated with the variable in the client management information base. The asynchronous master Trap or Inform message will include or refer to the client Trap or Inform information within a master object identifier associated with the corresponding asynchronous Trap or Inform in the master management information base.

For a better understanding of the present invention, together with other and further aspects thereof, reference is made to the following description, taken in conjunction with the accompanying drawings. The scope of the present invention is set forth in the appended clams.

### BRIEF DESCRIPTION OF THE DRAWINGS

FIG. 1 is a block diagram representing a system for providing network management services to a plurality of management clients in accordance with on embodiment of the present invention;

FIG. 2 is a block diagram of an exemplary management client in accordance with one embodiment of the present invention;

FIG. 3 is a flow chart representing exemplary operation of a proxy client in accordance with one embodiment of the present invention;

FIG. 4a is a flow chart representing exemplary operation of a connection module in accordance with one embodiment of the present invention;

FIG. 4b is a flow chart representing exemplary operation of a device state machine in accordance with one embodiment of the present invention;

FIG. 5 is a flow chart representing exemplary operation of a request state machine in accordance with one embodiment of the present invention;

FIG. 6 is a diagram representing exemplary structure of a request messages and response messages in accordance with one embodiment of the present invention;

FIG. 7 is a diagram representing exemplary structure of a heart beat message in accordance with one embodiment of the present invention;

FIG. 8 is a diagram representing exemplary master network management messages in accordance with the present invention;

FIGS. 9a and 9b are flow charts representing exemplary operation of a message handling module in accordance with one embodiment of the present invention;

FIG. 10 is a diagram representing exemplary structure of an asynchronous client Trap message and a corresponding asynchronous master Trap message in accordance with one embodiment of the present invention; and

FIG. 11 is a diagram representing an exemplary Trap rules table in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

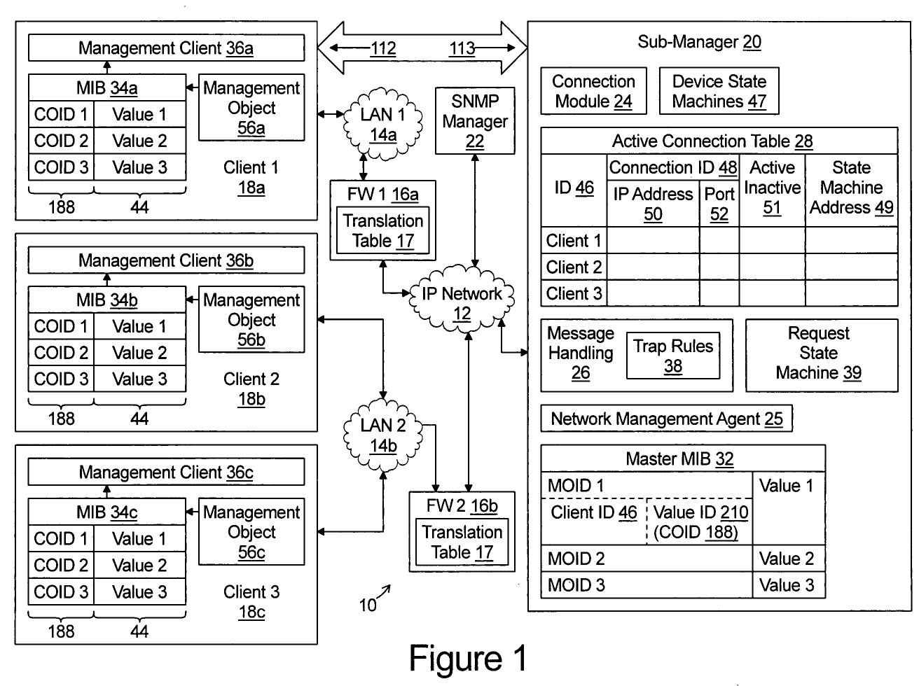

FIG. 1 represents a system 10 for providing network management services to a plurality of management clients 18a, 18b, and 18c in an environment wherein each management client 18a, 18b, and 18c may be coupled to a private network 14a or 14b and served by a network address and port translation firewall 16a and 16b.

The system 10 includes a network management system (NMS) 22 coupled to a frame switched Internet 12. Also coupled to the Internet 12 are a sub-manager 20 and each of the firewalls 16a and 16b. Each of such devices is assigned a globally unique IP address that is routable on the Internet 12 and each operates a suite of IP protocols that enable the device to set up TCP/IP logical connections and/or communicate over UDP/IP channels with other devices utilizing the Internet protocols.

Each firewall 16a and 16b is a known firewall system that includes network address and port translation (NAPT) functions and operates as a gateway to private networks 14a and 14b respectively. Each private network 14a, 14b is an IP compliant network and each client 18a, 18b, and 18c coupled to a private network 14a, 14b, (and other devices coupled to the private network) operates a suite of IP protocols that enable the device to set up TCP/IP logical connections and/or UDP/IP channels with other devices on the private network 14a and 14b utilizing the Internet protocols.

The NAPT function of each firewall 16a, 16b enables each device on the private network to share a single IP address assigned to the firewall 16a or 16b. More specifically, each device on the private network 14a, 14b is assigned a private IP address selected from a group of addresses reserved for private network use and unrouteable on the Internet 12. While each private network IP address assigned to a device is unique on the particular network on which the device is located, the same address may be assigned to other devices on other private networks.

When a device (such as client 18a) on a private network (such as private network 14a) opens a TCP/IP connection with a globally addressable device coupled to the Internet 12 (such as the sub-manager 20), the client 18a sends a TCP/IP connection request on the private network 14a. The TCP/IP connection request is routed to the NAT firewall 16a where it undergoes both IP address and port translation before being routed to the sub-manager 20 on the Internet 12.

More specifically, the NAT firewall 16a replaces the source IP address (e.g. the private network IP address of the client 18a) with the globally routable IP address of the NAT firewall 16a and replaces the source port number (e.g. port number assigned by the client 18a) with a selected dynamic port of the NAT firewall 16a. The NAT firewall 16a further maintains a translation table 17a in which it associates the private network address of the client 18a and the port number assigned by the client 18a with the selected dynamic port number. This translation table enables the NAT firewall 16a to “reverse route” a response frame received from the sub-manager 20 addressed to the NAT firewall 16a and to the selected dynamic port.

The NMS 22 is a known Simple Network Management Protocol (SNMP) compliant management server that utilizes the SNMP protocols for: i) querying SNMP agents for management information, and ii) receiving asynchronous Trap messages from SNMP agents comprising management information.

As previously discussed in the background section, SNMP messages are sent utilizing UDP/IP channels. More specifically, the NMS 22 may, at any time, address an SNMP message to an agent utilizing the agents IP address and a well known port utilized for SNMP (e.g. port 161). The agent may, at any time, address an asynchronous Trap to the NMS 22 utilizing the IP address of the NMS 22 and a well known port for SNMP Traps (e.g. port 162). The NAPT functions of each firewall 16a and 16b prevent the NMS 22 from sending a SNMP message to any device served by the firewall 16a or 16b. More specifically, the NAPT firewall 16a, 16b can only route inbound IP frames that are sent in response to an outbound IP frame such that an entry within the translation table 17a of the NAPT firewall 16a can be used to reverse translate the frame.

The sub-manager 20 operates as an SNMP agent to the NMS 22 by providing the NMS 22 with variable values 44 corresponding to a master management information base 32 (e.g. a Master MIB). The sub-manager 20 obtains these variable values 44 from the management information base 34 of each of the clients 18a-18c.

To obtain management information base 34 values from each of the clients 18a-18c, the sub-manager 20 maintains a TCP/IP connection 45 with each client 18a-18c through the firewall 16a, 16b serving the client. SNMP formatted messages are exchanged with each client 18a-18c over the TCP/IP connection 45. When variable values 44 identified by a client object identifier 188 from the management information base 34 are received from a client 18a-18c, the sub-manager 20 redefines each variable value 44 with a master object identifier 182 from the master management information base 32 and provides such master management information base 32 values to the NMS 22 using SNMP messages over traditional UDP/IP channels. A more detailed discussion of the structure and operation of the sub-manager 20 is included herein.

Client

In the exemplary embodiment, each client 18a-18c is customer premises equipment (CPE) for an Internet telephony system operated by an Internet telephony service provider. The service provider controls the NMS 22 and the sub-manager 20 for managing the clients 18a-18c.

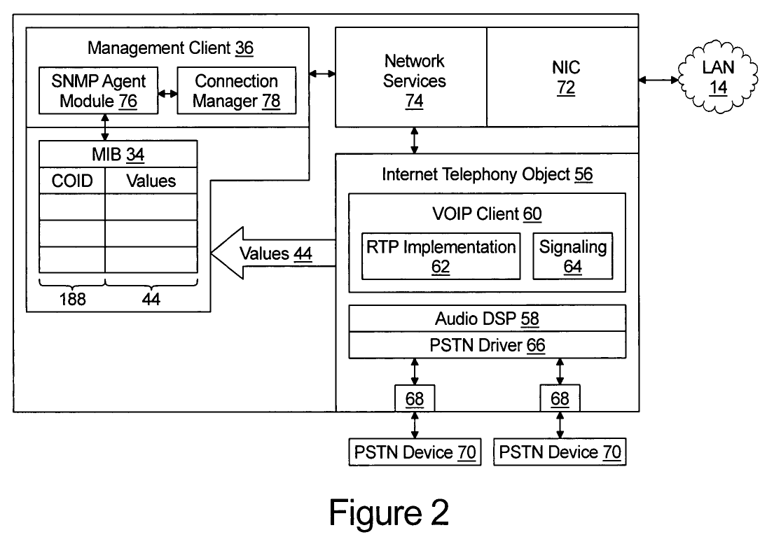

Referring briefly to FIG. 2, each CPE 18 comprises a network interface 72, an IP network services module 74, an Internet telephony object 56, and a management client 36.

The network interface module 72 utilizes known physical layer protocols which are compliant with those utilized on the private network 14 such that IP frames may be exchanged between the CPE 18 over the network 14 and the Internet 12.

The IP network services module 74 formats application level data into TCP/IP or UDP/IP frames for transmission to remote devices over the network 14 and the Internet 12.

The Internet telephony object 56 operates as a PSTN gateway for the plurality of PSTN devices 70. More specifically, the Internet telephony object 56 includes a VoIP client 60, an audio DSP 58, a PSTN driver module 66, and a plurality of PSTN ports 68.

The PSTN driver module 66 emulates a PSTN subscriber loop on each of a plurality of PSTN ports 68 for interfacing with traditional PSTN devices 70 utilizing in-band analog or digital PSTN signaling. The PSTN driver module 66 is coupled to the audio DSP 58 which in turn couples to the VoIP client 60.

The VoIP client 60 comprises a real time protocol implementation module 62 and a signaling module 64. The VoIP client 60 provides for operation of the CPE 18 within the Internet telephony service provider's system. More specifically, the VoIP client 60 interfaces with the PSTN driver module 66 (through the audio DSP 58) during call set up and exchanges VoIP call signaling with remote VoIP devices such as a soft switch, a call agent, and other VoIP signaling endpoints.

The signaling module 64 (through the audio DSP 58): i) detects PSTN events on each PSTN port 68 (through the PSTN driver 66) such as Off Hook, On Hook, Flash Hook, DTMF tones, Fax Tones, TTD tones and generates applicable VoIP signaling messages for sending to a remote signaling endpoint over the network 14 and Internet 12 (both of FIG. 1); and ii) generates PSTN signaling (through the PSTN driver 66) such as Ring, Dial Tone, Confirmation Tone, and in band caller ID in response to applicable VoIP signaling received from a remote VoIP endpoint.

The real time protocol implementation module 62, in conjunction with the audio DSP 58 converts between PSTN audio media and compressed digital audio media. More specifically, the real time protocol implementation module 62 operates during a media session to: i) encapsulate compressed digital audio media generated by the audio DSP 58 into real time protocol frames for transmission to the remote endpoint during a media session; and ii) receives and sequences real time protocol frames received from the remote endpoint and presents the compressed digital audio media encapsulated therein to the audio DSP 58.

The audio DSP 58 operates algorithms which convert between the digital audio media exchanged with the PSTN driver module 66 and compressed digital audio media exchanged with the real time protocol implementation module 62 utilizing a compression algorithm stored as part of audio DSP firmware.

The management client 36 reports various operating variable values 44 of the Internet telephony object 56 to the sub-manager 20. Each of the variable values 44 corresponds to, and is identified by, a client object identifier 188. All of the client object identifiers 188 are organized in a management information base 34. Each client object identifier 188 in the management information base 34 complies with the required management information base structures of the SNMP protocol.

The management client 36 comprises an SNMP agent module 76 and a connection manager 78. The SNMP agent module 76 operates as a traditional SNMP agent receiving SNMP query messages and generating both query response messages and asynchronous Trap messages with variable values from the management information base 34. Provided however, while a traditional SNMP agent will exchange SNMP messages with its SNMP management server utilizing UDP/IP protocols over the SNMP defined UDP ports, the SNMP agent module 76 exchanges the messages (using processing calls) with only the connection manager 78 which in turn exchanges the messages with the sub-manager 20 over the TCP/IP channel 45.

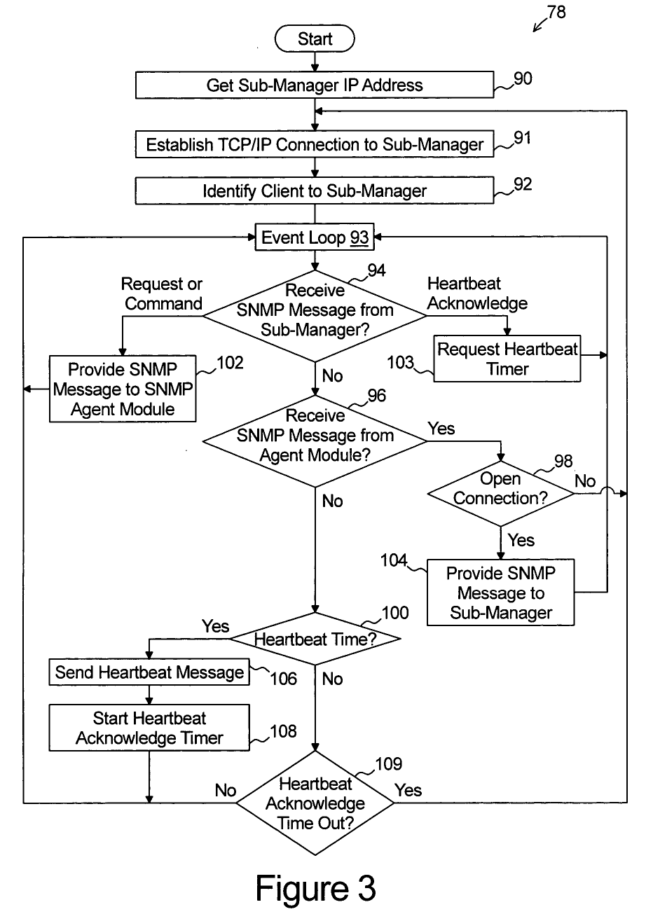

The connection manager 78 maintains an open TCP/IP connection 45 with the sub-manager 20. The flow chart of FIG. 3 represents exemplary operation of the connection manager 78. Referring to FIG. 3 in conjunction with FIG. 1, step 90 represents obtaining the IP address of the sub-manager 20. The sub-manager 20 will have a globally unique Internet routable IP address that will typically be provided to the CPE 18 during provisioning.

Step 92 represents establishing a TCP/IP connection 45 with the sub-manager 20. The connection manager 78, operating at the application layer, will interface with the network services module 74 to initiate the TCP/IP connection by initiating a three-way TCP handshake with the sub-manager 20. Further, if a secure connection is established, a TLS connection will follow establishment of the TCP/IP connection 45. If at step 92 any connection request fails, the connection manager 78 will wait a random back-off time and then repeat its attempt to establish the TCP/IP connection 45.

After the TCP/IP connection 45 is established with the sub-manager 20, the connections module 78 identifies the CPE client 18 to the sub-manager 20 at step 92. Step 92 includes sending an SNMP Inform message (which also functions as the first heart beat message 113) with a unique identifier such as a number derived from the MAC address of the client 18. Following step 92, the connection manager 78 operates as an event driven state machine sustaining an event loop at box 93 with four exemplary events triggering the connections module 78 to perform corresponding actions.

First, an SNMP message may be received over the TCP/IP connection 45 from the sub-manager 20; secondly, an SNMP message may be received from the local SNMP agent module 76 for transmission over the TCP/IP connection 45 to the sub-manager 20; thirdly, a heart beat timer event may occur indicating that a heart beat message 113 must be sent over the TCP/IP connection 45 to the sub-manager 20; and fourthly, a predetermined period of time may expire during which no heart beat acknowledgement message 112 was received over the TCP/IP connection from the sub-manager 20. These four events are represented by decision steps 94, 96, 100, and 109 respectively of the flow chart of FIG. 3.

In the event that an SNMP message is received over the TCP/IP connection 45 from the sub-manager 20 at decision step 94, the connection manager 78 either: i) provides, at step 102, such SNMP message to the local SNMP agent module 76 if the SNMP message is a request or command message; or ii) resets, at step 103, a heart beat timer (e.g. time used to trigger the next heart beat message 113) if the SNMP message is a heart beat acknowledgement message 112. In either case, the state machine returns to the event loop 93 thereafter to wait for a next trigger event.

In the event that an SNMP message (either a response SNMP message or an asynchronous Trap message) is received from the local SNMP agent module 76 at decision step 96, the connection manager 78 then determines if the connection to the sub-manager 20 remains open at step 98. If the connection is open, the connection manager 78 provides such SNMP message to the sub-manager 20 over the TCP/IP connection 45 at step 104 and thereafter returns to event loop 93. If it is discovered that the connection to the sub-manager 20 is severed at decision box 98, the connection manager 78 will stop the heartbeat timer and attempt to re-establish the connection at step 92.

In the event that a timer event indicates that a heart beat message 113 must be sent at decision step 100, such message is sent over the TCP/IP connection 45 to the sub-manager 20 at step 106 and a heart beat acknowledgement timer is started at step 108.

In the event that the predetermined period of time has expired (as determined by the heart beat acknowledgement timer) during which no heart beat acknowledgement message 112 was received over the TCP/IP connection 45 from the sub-manager 20 as represented by decision step 109, the connection manager 78 initiates a new TCP/IP connection to the sub-manager 20 at step 92.

Sub-Manager

As previously discussed, the sub-manager 20 operates as an SNMP agent to the NMS 22 by providing the NMS 22 with variable values defined by master object identifiers 182 from the master management information base 32. The sub-manager 20 obtains values for the master management information base 32 from the management information base 34 of each of the CPE clients 18a-18c. As discussed, the sub-manager 20 maintains a TCP/IP connection 45 with each CPE client 18a-18c, through the firewall 16a, 16b serving the client, and exchanges SNMP messages with each client over the TCP/IP connection 45.

The sub-manager 20 comprises a network management agent module 25, a message handling module 26, a connections module 24, an active connections table 28, a master management information base 32, a plurality of device state machines 47, and a plurality of request state machines 39.

The network management agent module 25 operates as a traditional SNMP agent by exchanging SNMP messages with the NMS 22 utilizing UDP/IP protocols and the SNMP defined UDP ports. Referring briefly to FIG. 8, the SNMP messages exchanged between the NMS 22 and the network management agent module 25 are master network management messages 190 and include master network management request messages 170, master network management response messages 192, and asynchronous master Trap messages 194—each of which is discussed in more detail herein.

While a traditional SNMP agent will respond to SNMP query messages and generate asynchronous Trap messages with variable values from its management information base, the network management agent 25 will not process or generate any messages for variables whose values need to be retrieved from a client 18, but will pass each such message (using processing calls) to the message handling module 26 and pass each message received from a request state machine 39 to the NMS 22 utilizing the SNMP defined UDP ports.

The connection module 24 opens the TCP/IP or TLS connection 45 with each of the clients 18a-18c. The connection module 24 further spawns the device state machine 47 for: i) maintaining the open connection 45 utilizing heart beat messages 113; and ii) exchanging SNMP compliant messages with each client 18a-18c and over the open connection 45 with the client.

The message handling module 26: i) spawns each request state machines 39 for performing management information base (MIB) translation and aggregation; and ii) maintains Trap rules 38 for handling asynchronous Trap messages provided by a client 18.

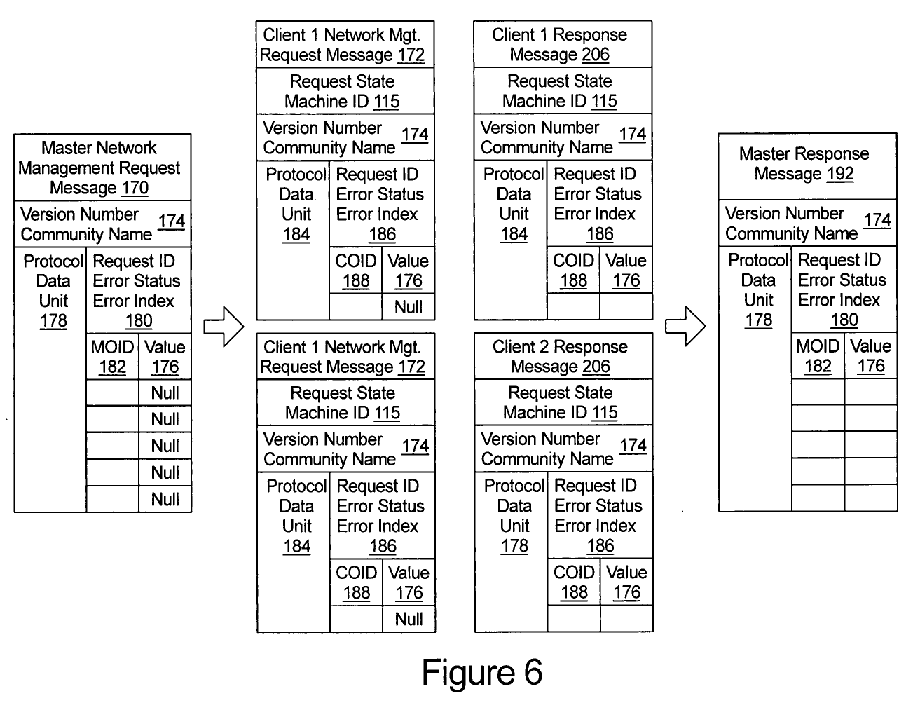

With respect to request and response messages, and referring briefly to FIG. 6, the message handling module 26 receives each master network management request message 170 from the NMS 22 and spawns a request state machine 39 to generate a plurality of client network management request messages 172 for sending to applicable clients. The request state machine 39 then receives a client response message 206 from each of the clients and aggregates the responses received from each client to generate a master response message 192. Additional discussion of each of the connection module 24, message handling module 26, network management agent 25, device state machines 47, and request state machines 39 is included herein.

Connection Module

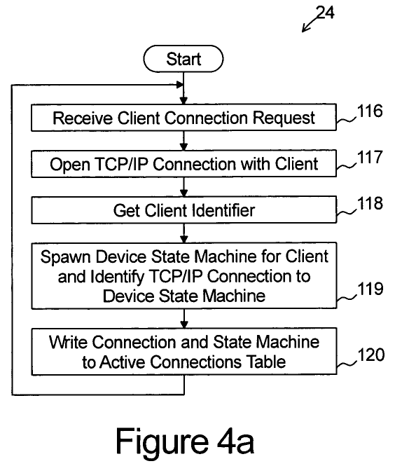

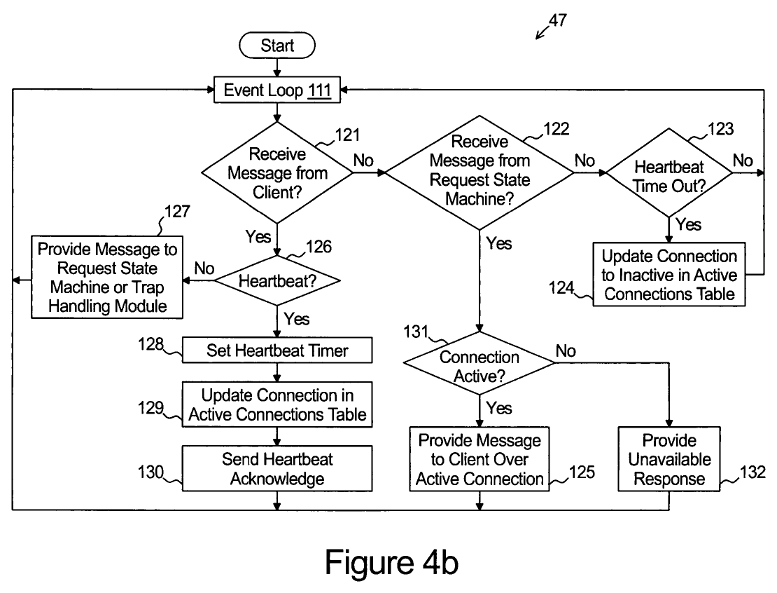

The connection module 24 opens the TCP/IP or TLS connection 45 with each of the clients 18a-18c. Referring to the flow chart of FIG. 4a in conjunction with FIG. 1, operation of the connection module 24 is represented. Step 116 represents the connection module 24 receiving a TCP/IP connection request from a client 18 and step 117 represents opening the TCP/IP connection 45 with the client 18.

Step 118 represents receiving the client identifier 46 from the client 18. As previously discussed, the client 18 will send an SNMP Inform message stating its client identifier 46.

Step 119 represents spawning a device state machine 47 for the client 18 and identifying the TCP/IP connection 45 (by the TCP/IP connection identifier 48) to the device state machine 47 such that further communications over the TCP/IP connection 45 may be handled by the device state machine 47. The connection module 24 will spawn a device state machine 47 for each client 18 which has established a TCP/IP connection to the sub-manager 20.

The TCP/IP connection identifier 48 may be determined from the source IP address 50 and the source port number 52 of the SNMP Inform message initiated by the client 18 (and translated by the client's firewall 16) and sent to the sub-manager 20 over the TCP/IP connection 45.

Step 120 represents associating with the client identifier 46, in the active connections table 28, each of: i) a device state machine identifier 49 such as the memory address of the state machine 47; ii) a client connection identifier 48; and iii) an identifier 51 indicating whether the TCP/IP connection 45 with the device is active or inactive.

Device State Machine

Following completion of the steps of the flow chart of FIG. 4a, and referring to the flow chart of FIG. 4b in conjunction with FIG. 1, the device state machine 47 operates in an event loop 111 with three exemplary events triggering the connections module 24 to perform corresponding actions associated with the device 18. First, a message may be received from the client 18 on the TCP/IP connection 45. Secondly, a message may be received from a request state machine 39 for the client 18. And thirdly, a duration of time since receiving a heart beat message 113 may have elapsed during which a new heart beat message 113 was not received. These three exemplary events are represented by steps 121, 122, and 123 of the flow chart of FIG. 4b respectively.

If a message is received from the client 18 on the TCP/IP connection 45 as determined at decision step 121, the connection module 24 determines whether the message is a heart beat message 113 at step 126. If the message is not a heart beat message 113, but instead is an asynchronous Trap or Inform message, the message is providing to the message handling module 26 for handling in accordance with the Trap rules 38 at step 127. If the message is not a heart beat 113, but instead is a response message, the message is provided to the request state machine 39 identified in the response message (f the identified state machine still exists). In either case, the state machine returns to the event loop 111 thereafter.

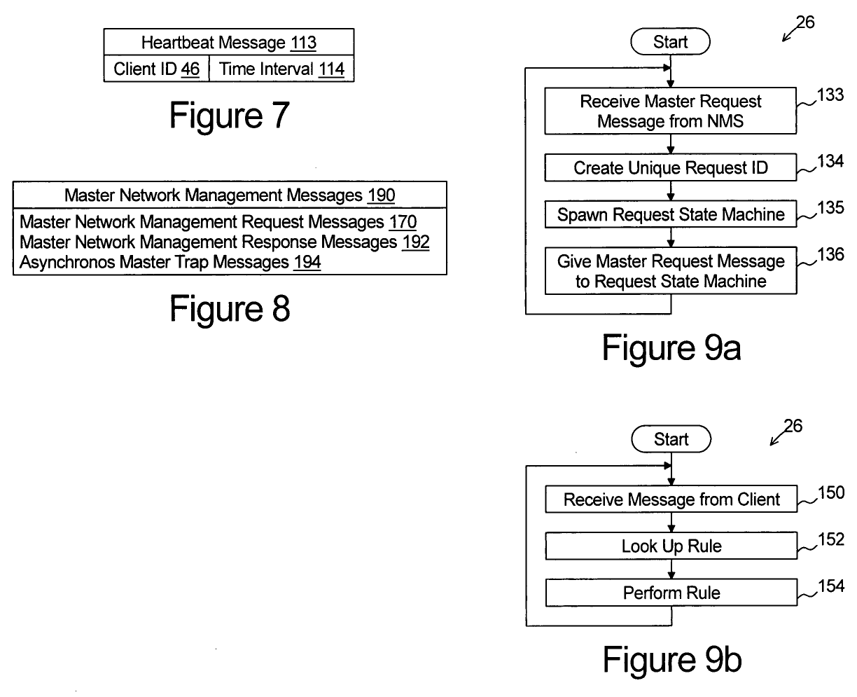

If the message received from the client 18 is a heart beat message 113, the device state machine 47 sets a time duration for a heart beat time out timer at step 128. More specifically, referring to FIG. 7, each heart beat message 113 will include a time interval 114 during which the client 18 will send the next heart beat message 113, the time duration for the heart beat timer is set to this interval.

Step 129 represents updating the TCP/IP connection 45 in the active connections table. In certain circumstances, the TCP/IP connection may have become inactive or the heart beat message 113 may have been translated by the firewall utilizing a different dynamic port. Step 129 represents writing any updates to the client connection ID 48 in the active connections table 28.

Step 130 represents providing a heart beat acknowledge message 112 back to the client 18 on the TCP/IP channel 45 and thereafter returning to the event loop 111.

In the event that a client request message 172 (FIG. 6) is received from a request state machine 39 as determined at step 122, then the device state machine 47 determines whether the TCP/IP connection 45 is active by reference to the active connection table 28. If the connection 45 is active, the client request message 172 is provided to the client 18 over the TCP/IP connection 45 at step 125.

Alternatively, if the TCP/IP connection 45 is inactive, then the device state machine 47 provides an unavailable response back to the request state machine 39 at step 132. In either case the device state machine 47 returns to the event loop 111 thereafter.

In the event that the heart beat timer exceeds the duration of time specified in the previous heart beat message 113 (or a multiple of the duration of time specified in the previous heart beat message 113) during which a subsequent heart beat message 113 was not received as determined at step 123, it can be assumed that the TCP/IP connection 45 no longer exists. Step 124 represents updating the indication 51 in the active connections table 28 to reflect the TCP/IP connection 45 being inactive.

Message Handling Module

The flow chart of FIG. 9a represents exemplary operation of the message handling module 26 when a master network management request message 170 (FIG. 6) is received from the NMS 22 by the network management agent 25. Step 133 represents receiving the master network management request message 170.

Turning briefly to FIG. 6, the structure of a master network management request message 170 is shown. The master network management request message 170 includes SNMP overhead fields 174 such as a version number and a community name and at least one protocol data unit 178. Each protocol data unit 178 comprises overhead fields 180 such as a request ID, an error status, and an error index. In addition, each protocol data unit 178 includes a plurality of variable values 44 with each value 76 being identified by a master object identifier 182 selected from within the master management information base 32.

Because the master network management request message 170 is a request message (e.g. a message intended to solicit a reply message with the requested variable value 44 from the sub-manager 20), each variable value 44 in the request message 170 is a null value.

Returning to the flow chart of FIG. 9a in conjunction with FIGS. 1 and 6, step 134 represents creating a unique ID number for the received request for inclusion in client request messages 172 and for associating client response messages 206 with the master network management request message 170.

Step 135 represents spawning a request state machine 39 which will operate as an event driven state machine performing certain operations in response to events related to the request. A unique request state machine identifier 115 is assigned to each request state machine 39.

Step 136 represents passing the master network management request message 170 to the request state machine 39 for handling as discussed herein.

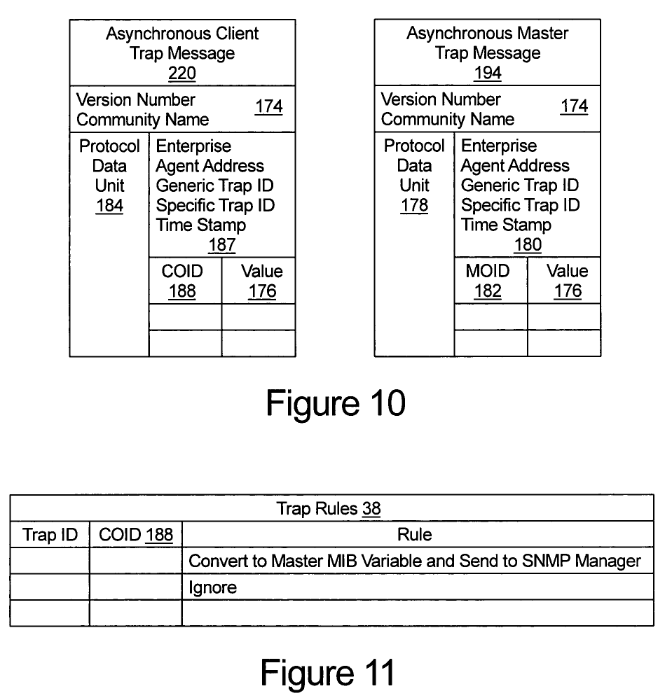

The flow chart of FIG. 9b represents exemplary operation of the message handling module 26 when an asynchronous Trap or Inform message (FIG. 10) is received from a client 18. Step 150 represents receiving such a message. An asynchronous Trap message 220 must be handled in accordance with a rule specific to the Trap ID and/or client object identifier 188 included with in the asynchronous Trap message 220. The asynchronous client Trap message 220 may include the SNMP overhead fields 174 (e.g. the version number and a community name) and at least one protocol data unit 184. Each protocol data unit 184 comprises Trap overhead fields 187 such as: i) an enterprise field identifying the management object initiating the Trap; ii) an agent address identifying the IP address of the agent initiating the Trap; iii) a generic Trap id identifying a standard Trap; iv) a specific Trap id identifying a proprietary Trap; and v) a time step indicating when the Trap was initiated. In addition, the each protocol data unit 178 includes a plurality of information values 44 with each value 44 being identified by its client object identifier 188.

The message handling module 26 determines what operations to perform upon receipt of an asynchronous Trap message 220 by looking up a rule applicable to the received Trap message 220 in a Trap rules table 38 (FIG. 11) at step 152. Step 154 represents the message handling module 26 performing in accordance with the rule.

Referring briefly to FIG. 11, an exemplary Trap rules table 38 includes, for each combination of possible combination of Trap IDs and client object identifiers 188, instruction for handling the Trap. A default rule to ignore the Trap is applicable for any Trap without a recognized Trap ID and client object identifier 188 that makes another rule applicable. One common rule is to generate an asynchronous master Trap message 194 from the client Trap message 220 and provide the master Trap message to the NMS 22. The master Trap message 194 will have the same format as the client Trap message 220 except that each client object identifier 188 identifying a Trap value will be replaced by its corresponding master object identifier 182 and the Trap information from the device will be contained within the master Trap object along with the client ID of the device 18.

Request State Machine

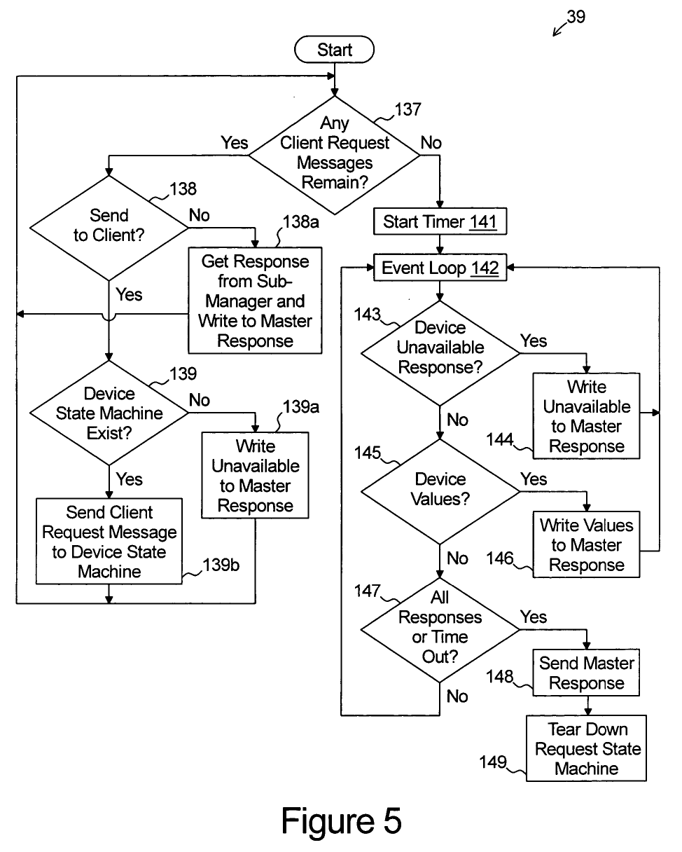

Referring to the flow chart of FIG. 5 in conjunction with FIGS. 1 and 6, operation of the device state machine 39 is discussed. Because each network management request message 170 may require generating multiple client network management request messages 172, the iterative cycle of steps 137, 138, 138a, 139, 139a, and 139b represent generating the multiple client network management request messages 172 and forwarding each to the applicable device state machine 47.

More specifically, step 137 represents determining whether a client network management request message 172 needs to be generated or, more specifically, determining which client 18 has the requested variable value 44 within its client management information base 34 and determining the client object identifier 188 that corresponds to the variable value 44. The master object identifier 182 of the master network management request message 170 includes the client identifier 46 and a variable identification portion 210. The client identifier 46 identifies the client 18 which has the client management information base 34 that includes the requested variable value 44. The variable value identification portion 210 may be the client object identifier 188 that identifies the variable value 44 within the client management information base 34.

Step 138 represents determining whether the client network management request message 172 needs to be sent to a client 18 for response. If the requested information is available locally at the sub-manager 20 (such as in the master MIB 34), step 138a represents writing such locally available information to the master response message 192. If a client network management request message 172 must be sent to a device state machine 47, step 139 represents determining whether a device state machine 47 exists for the identified client 18. More specifically, step 139 represents locating the device state machine address 49 corresponding to the client 18 46 in the active connection table 28.

If a device state machine 47 does not exist, an indication that the client 18 is unavailable is written to the master response message 192 at step 139a. If the device state machine 47 exists, the client network management request messages 172 is generated and forwarded to the applicable device state machine 47 at step 139b.

After each client network management request message 172 has been sent to the applicable device state machine 47 (or it has been determined that the client 18 is unavailable the request state machine 39 starts a response timer at step 141 and thereafter enters an event loop 142 wherein three trigger events may occur.

In the event that a device unavailable response is received from a device state machine 47 at decision box 143, then the request state machine 39 writes an indication that the client 18 is unavailable to the master response message 192 at step 144 and thereafter returns to the event loop 142.

In the event that a response is received from a device state machine 47 that includes variable values at decision box 145, then the request state machine 39 writes the variable values to the master response message 192 at step 146 and thereafter returns to the event loop 142.

In the event that either: i) responses have been received from all device state machines 47; or ii) the timer started at step 141 has expired, as determined at decision box 147, then the request state machine 39 will send the master response message 192 at step 148. It should be appreciated that in the event that the master response message 192 is sent as the result of the timer expiring, it will be incomplete.

Following sending of the master response message 192 at step 148, the response state machine 47 is torn down at step 149.

Summary

In summary, it should be appreciated that the systems and methods of the present invention enable management of a plurality of clients by a traditional SNMP NMS even when a plurality of the managed clients are located on private networks and are served by a network address and port translation firewall.

Although the invention has been shown and described with respect to certain preferred embodiments, it is obvious that equivalents and modifications will occur to others skilled in the art upon the reading and understanding of the specification. For example, while the TCP/IP connections discussed operate on a one to one basis between the sub-manager and each client, it is possible for multiple clients to share a TCP/IP connection with the sub-manager. The present invention includes all such equivalents and modifications, and is limited only by the scope of the following claims.

1. A sub-manager (20) for interfacing between a network management system (22) and a plurality of clients (18), each of such clients (18) being served by a firewall (16), the sub-manager (20) comprising:
a network management agent (25) for exchanging master network management messages (190) with the network management system (22);
a connections module (24) for establishing a network connection (45) with each of the plurality of clients (18);
a message handling module (26) for:
receiving a master network management request message (170) from the network management system (22), the master network management request message (170) including a plurality of master object identifiers (182), each master object identifier (182) comprising a client identifier (46) that identifies a particular one of the clients (18) and a variable portion (210) that identifies a variable value (44) within a client management information base (34);
generating at least one client network management request message (172), each client network management request message (172) including a client object identifier (188) that identifies the variable value (44) within the client management information base (34);
providing each client network management request message (172) to the particular one of the clients (18) identified by the client identifier (46) over the network connection (45) established with such particular one of the clients (18);
receiving a client response message (206) from each of the particular one of the clients (18) to which a client network management message (172) was provided, each client response message (206) including the client object identifier (188) and the variable value (44);
aggregating each client response message (206) to generate a master response message (192), the master response message (192) including the plurality of master object identifiers (182) and each master object identifier (182) comprising the client identifier (46) and the variable value received in the client response message (206); and
providing the master response message (192) to the network management system (22).

2. The sub-manager (20) of claim 1, wherein the variable portion (210) of the master object identifier (182) is the client object identifier (188).

3. The sub-manager (20) of claim 1, wherein:
each connection (45) is a TCP/IP connection that is established with a client (18), through the firewall (16) serving such client (18) in response to receiving a connection request initiating by such client (18);
the connections module (24) further records, in an active connections table (28), for each connection (45), a client connection identifier (48) in association with the client identifier (46) identifying the client (18) that initiated the connection (45); and
a device state machine provides the client network management request message (172) to the particular one of the clients (18) by providing the client network management request (172) over the connection (45) that associates with the particular one of the clients (18) in the active connections table (28).

4. The sub-manager (20) of claim 3, wherein the client connection identifier (48) is a source IP address (50) and a source port number (52) obtained from a TCP/IP frame initiated by the client (18) with which the connection (45) is established.

5. The sub-manager (20) of claim 1 wherein the device state machine further provides for:
periodically receiving a heart beat message (113) from the client (18) over the connection (45); each heart beat message (113) including the client identifier (46) and a time interval (114) between the heart beat message (113) and a subsequent heart beat message (113);
updating the client connection identifier (48) in the active connection table (28) if the source IP address (50) or the source port number (52) obtained from the heart beat message (113) differs from that of a previous heart beat message (113);
providing a heart beat acknowledgement message (112) to the client (18) over the connection (45); and
determining that the connection (45) is inactive if a time period in excess of the time interval (114) elapses during which a subsequent heart beat message (113) has not been received.

6. The sub-manager (20) of claim 5, wherein the master response message (192) includes an indication that the a value (44) does not exist if the value (44) is associated with a master object identifier (182) that includes a client identifier (46) associated with a client 18 with which the connection (45) is inactive.

7. The sub-manager (20) of claim 1, wherein:
the master network management request message (172) comprises at least two master object identifiers (182), each master object identifier (182) comprising a client identifier (46) that is unique from the client identifier (46) of at least one other master object identifier (182);

8. The sub-manager (20) of claim 1, wherein the message handling module 26 further provides for:
receiving an asynchronous client Trap message (220) initiated by client (18) over the connection (45) established with the client (18), the asynchronous client Trap message (220) including a client object identifier (188) and a variable value (44) associated with the client object identifier (188);
identifying the client (18) that initiated the asynchronous client Trap message (220); and
generating an asynchronous master Trap message (194) and providing the asynchronous master Trap message (194) to the network management system (22), the asynchronous master Trap message (194) including the value (44) and a master object identifier (182), the master object identifier (182) including a client identifier (46) identifying the client (18) that initiated the asynchronous client Trap message (22) and a variable portion (210) identifying the variable value (44).

9. The sub-manager (20) of claim 8, wherein the variable portion (210) of the master object identifier (182) is the client object identifier (188).

10. A method of interfacing between a network management system (22) and a plurality of clients (18), each of such clients (18) being served by a firewall (16), the method comprising:
establishing a connection (45) with each of the plurality of clients (18);
receiving a master network management request message (170) from the network management system (22), the master network management request message (170) including a plurality of master object identifiers (182), each master object identifier (182) comprising a client identifier (46) that identifies a particular one of the clients (18) and a variable portion (210) that associates with a variable value (44) within a client management information base (34);
generating at least one client network management request message (172), the client network management request message (172) including a client object identifier (188) that identifies the variable value (44) within the client management information base (34);
providing each client network management request message (172) to the particular one of the clients (18) identified by the client identifier (46) over the network connection (45) established with such particular one of the clients (18);
receiving a client response message (206) from each of the particular one of the clients (18) to which a client network management message (172) was provided, each client response message (206) including the client object identifier (188) and the variable (44);
aggregating each client response message (206) to generate master response message (192), the master response message (192) including the plurality of master object identifiers (182) and each master object identifier (182) comprising the client identifier (46) and the variable value (44) received in the client response message; and
providing the master response message to the network management system (22).

11. The method of claim 10, wherein the variable portion (210) of the master object identifier (182) is the client object identifier (188).

12. The method of claim 10, wherein:
each connection (45) is a TCP/IP connection established with a client (18), through the firewall (16) serving such client (18), in response to receiving a connection request initiating by such client (18);
the method further comprises recording in an active connections table (28), for each connection (45) established, a client connection identifier (48) in association with the client identifier (46) identifying the client (18) that initiated the connection (45); and
the step of providing each client network management request message (172) to the particular one of the clients (18) comprises providing each client network management request (172) over the connection (45) that associates with the particular one of the clients (18) in the active connections table (28).

13. The method of claim 12, wherein the client connection identifier (48) is a source IP address (50) and a source port number (52) obtained from a TCP/IP frame initiated by the client (18) with which the connection (45) is established.

14. The method of claim 10 further comprising:
periodically receiving a heart beat message (113) from the client (18) over the connection (45); each heart beat message (113) including the client identifier (46) and a time interval (114) between the heart beat message (113) and a subsequent heart beat message (113);
updating the client connection identifier (48) in the active connection table (28) if the source IP address (50) or the source port number (52) obtained from the heart beat message (113) differs from that of a previous heart beat message (113);
providing a heart beat acknowledgement message (112) to the client (18) over the connection (45); and
determining that the connection (45) is inactive if a time period in excess of the time interval (114) elapses during which a subsequent heart beat message (113) has not been received.

15. The method of claim 14, wherein the master response message (192) includes an indication that the value (44) is unavailable if an open connection (45) does not exist with the particular on of the clients (18).

16. The sub-manager (20) of claim 10, wherein:
the master network management request message (172) comprises at least two master object identifiers (182), each master object identifier (182) comprising a client identifier (46) that is unique from the client identifier (46) of at least one other master object identifier (182);

17. The method of claim 10, further comprising:
receiving an asynchronous client Trap message (220) from a client (18) over the connection (45) established with the client (18), the asynchronous client Trap message (220) including a client object identifier (188) and a variable value (44) associated with the client object identifier (188);
identifying the client (18) that initiated the asynchronous client Trap message (220);
generating an asynchronous master Trap message (194) and providing the asynchronous master Trap message (194) to the network management system (22), the asynchronous master Trap message (194) including the variable value (44) and a master object identifier (182), the master object identifier (182) including a client identifier (46) identifying the client (18) that initiated the asynchronous client Trap message (22) and a variable portion (210) identifying the variable value (44).

18. the method of claim 17, wherein the variable portion (210) of the master object identifier (182) is the client object identifier (188).
